(19) United States
(12) Patent Application Publication
(10) Pub. No.: US 2008/0257808 A1
(43) Pub. Date: Oct. 23, 2008

(54) Ultrasonic Treatment Plant

(76) Inventor: David Michael Weeks, Oxfordshire (GB)

Correspondence Address: LAW OFFICES OF WILLIAM H. HOLT, 12311 HARBOR DRIVE, WOODBRIDGE, VA, 22192, US

(21) Appl. No.: 11/816,412

(22) PCT Filed: Feb. 1, 2006
(86) PCT No.: PCT/GB06/50027

§ 371 Date: Oct. 13, 2007

(30) Foreign Application Priority Data
Feb. 16, 2005 (GB) 0503193.5

(51) Int. Cl. F16L 9/14; H04R 31/00

(52) U.S. Cl. 210/181; 29/594; 138/145; 210/748; 210/805

(57) ABSTRACT

A duct (10) for use in an ultrasonic treatment plant is made from a cylindrical steel pipe (12) by plating the bore with a corrosion-resistant metal layer (14). This is preferably done by honing the bore to ensure that it is circular, plating the bore of the pipe (12) with the corrosion-resistant metal, and again honing the bore of the pipe to ensure that it is circular and to reduce the thickness of the corrosion-resistant metal, and coupling ultrasonic transducers (16) to the outside of the pipe (12). Where flanges (22) are attached to the ends of the pipe (12), these are fitted over each end of the pipe so the ends are flush, and welded to the outside of the pipe (12).

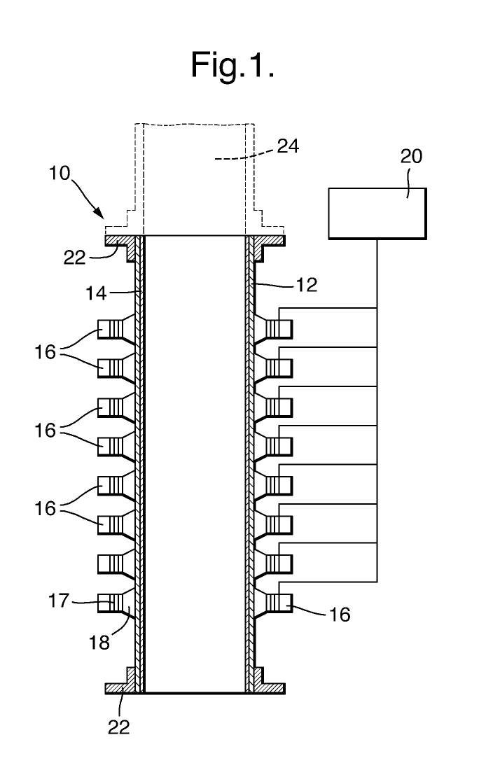

This invention relates to a plant for treating a liquid with ultrasound.

The use of high intensity ultrasound to trigger nucleation in a supersaturated solution, so that crystallisation occurs, is known, and apparatuses for this purpose are for example described in GB 2 276 567 A and WO 00/35579. The benefits of triggering nucleation in this fashion are of relevance when very pure crystalline products are to be formed, as described in WO 03/101577, as the purity of the solution and the cleanliness of the vessel surfaces mean that crystallisation nuclei are not otherwise present. Benefits can also arise when treating very impure solutions, for example in minerals processing, where the impurities may inhibit the desired crystallisation. In both of these apparatuses the ultrasound is supplied to the contents of a duct, and it is desirable that this duct should be of accurately circular cross-section and should have a smooth wall, to ensure good coupling of ultrasound into the contents. Where the liquids to be treated are corrosive, then there are restrictions on the materials for the ducts are made of. It is also desirable that the ducts should be easily refurbished.

According to the present invention there is provided a method of making a duct for use in an ultrasonic treatment plant, the method comprising selecting a cylindrical steel pipe, honing the bore of the pipe to ensure that it is circular, plating the bore of the pipe with a corrosion-resistant metal, and again honing the bore of the pipe to ensure that it is circular and to reduce the thickness of the corrosion-resistant metal, and coupling ultrasonic transducers to the outside of the pipe.

Preferably the method also comprises attaching flanges to each end of the pipe to form the duct, the flanges being tubular, with a bore matching the outer diameter of the pipe, the flange being fitted over the end of the pipe so the ends are flush, and being welded to the outside of the pipe.

Preferably the pipe is of stainless steel, and preferably the corrosion resistant metal is nickel, cobalt, or chromium, in particular hard-chromium, which can be deposited by electroplating.

The present invention also provides a duct for use in an ultrasonic treatment plant, the duct comprising a cylindrical steel pipe whose bore has been honed, plated with a corrosion-resistant metal, and again honed to reduce the thickness of the corrosion-resistant metal, and with ultrasonic transducers coupled to the outside of the pipe.

Preferably the duct also comprises flanges attached to each end of the pipe, the flanges being tubular, with a bore matching the outer diameter of the pipe, the flange fitting over the end of the pipe so the ends are flush, and being welded to the outside of the pipe.

The invention will now be further and more particularly described by way of example only and with reference to the accompanying drawing which shows a longitudinal sectional view of an ultrasonic treatment duct.

Referring to the drawing, an ultrasonic irradiation duct 10 includes a stainless-steel pipe 12 of internal diameter 0.15 m (nominal 6 inches bore) and of wall thickness 7 mm. The surface of the bore is coated with a layer 14 of hard chromium of thickness 500 μm. To the outside of the wall are attached forty transducer modules 16 closely packed in a rectangular array. Each transducer module 16 comprises a 50 W piezoelectric transducer 17 which resonates at 20 kHz, attached to a conically flared aluminium coupling block 18 by which it is connected to the wall, the wider end of each block being of diameter 63 mm. The transducer modules define eight circumferential rings each of five modules 16, the centres of the coupling blocks 18 being 105 mm apart in each ring, and being 114 mm apart along the length of the pipe 12. The irradiator 10 also incorporates a signal generator 20 (only one is shown) which drives the transducers 17.

At each end of the duct 10 is a flange 22 by which the duct 10 can be connected to other sections of pipework 24 (one such section being shown in part, in broken lines) by bolts (not shown). Each flange 22 consists of a steel ring which fits over the outside of the end of the pipe 12, so the ends of the pipe 12 and flange 22 are flush; the flange 22 is welded to the outside of the pipe 12, preferably using a J-prep, so that the welded material is entirely on the outside of the pipe 12. Consequently, when the duct 10 is connected to the adjacent pipework 24 the contents of the duct 10 do not come into contact with either the flange 22 or the weld. This reduces corrosion problems.

In preparing the duct 10, the flanges 22 are welded to the ends of the pipe 12 as described above. The bore is then honed to ensure it is of accurately circular cross-section. The bore is preferably etched, for example by anodic etching with 20% sulphuric acid, and is then electroplated to deposit a layer of hard chromium of thickness about 625 μm. The electroplating is preferably carried out using a conventional (non-fluoride) type of chromium plating solution. This surface is then honed again, so reducing the thickness to 500 μm, and so providing the layer 14 described above.

It has been found that this method of providing the layer 14 ensures that the chromium layer 14 shows no tendency to flake or peel off, as can happen if the bore is initially polished. The layer 14 is resistant to corrosion in both acid and alkaline conditions, and indeed in neutral solutions, and is more resistant to cavitational erosion than stainless-steel. Furthermore it is easy to refurbish the duct 10, after a period of use, by honing to remove the chromium, electroplating to deposit a thicker layer of chromium than is required, and honing again to obtain the desired thickness and surface finish.

It will be appreciated that the duct 10 is shown only by way of example, and that an ultrasonic irradiation duct of the invention may differ from that shown. For example the duct may be of a different wall thickness, and a different bore. The transducers may be coupled to the duct in a different fashion, and there may be a different number of transducers coupled to the duct. It will also be understood that the coating must be of a material which is resistant to corrosion by whatever liquid is to pass through the duct 10, and hence that the coating might instead be of nickel, for example.

1. A method of making a duct for use in an ultrasonic treatment plant, said method comprising selecting a cylindrical steel pipe, plating the bore of said pipe with a corrosion-resistant metal, and coupling ultrasonic transducers to the outside of said pipe.

2. A method of making a duct for use in an ultrasonic treatment plant, said method comprising selecting a cylindrical steel pipe, honing said bore of said pipe to ensure that it is circular, plating said bore of said pipe with a corrosion-resistant metal, and again honing said bore of said pipe to ensure that it is circular and to reduce the thickness of said corrosion-resistant metal, and coupling ultrasonic transducers to the outside of said pipe.

3. A method as claimed in claim 2 also comprising attaching flanges to each end of said pipe to form said duct, said flanges being tubular, with a bore matching the outer diameter of said pipe, said flange being fitted over the end of said pipe so the ends are flush, and being welded to the outside of said pipe.

4. A method as claimed in claim 2 wherein said pipe is of stainless steel, and said corrosion-resistant metal is selected from a group consisting of nickel, cobalt, and chromium.

5. A duct for use in an ultrasonic treatment plant, said duct comprising a cylindrical steel pipe whose bore has been plated with a corrosion-resistant metal, and with ultrasonic transducers coupled to the outside of said pipe.

6. A duct for use in an ultrasonic treatment plant, said duct comprising a cylindrical steel pipe whose bore has been honed, plated with a corrosion-resistant metal, and again honed to reduce the thickness of said corrosion-resistant metal, and with ultrasonic transducers coupled to the outside of said pipe.

7. A duct as claimed in claim 6 which also comprises flanges attached to each end of said pipe, said flanges being tubular, with a bore matching the outer diameter of said pipe, said flange fitting over the end of said pipe so the ends are flush, and being welded to the outside of said pipe.

8. A method as claimed in claim 1 also comprising attaching flanges to each end of said pipe to form said duct, said flanges being tubular, with a bore matching the outer diameter of said pipe, said flange being fitted over the end of said pipe so the ends are flush, and being welded to the outside of said pipe.

9. A method as claimed in claim 1 wherein said pipe is of stainless steel, and said corrosion-resistant metal is selected from a group consisting of nickel, cobalt, and chromium.

10. A method as claimed in claim 3 wherein said pipe is of stainless steel, and said corrosion-resistant metal is selected from a group consisting of nickel, cobalt, and chromium.

11. A duct as claimed in claim 5 which also comprises flanges attached to each end of said pipe, said flanges being tubular, with a bore matching the outer diameter of said pipe, said flange fitting over the end of said pipe so the ends are flush, and being welded to the outside of said pipe.
